(19) United States
(12) Patent Application Publication
(10) Pub. No.: US 2021/0175635 A1
(43) Pub. Date: Jun. 10, 2021

(54) COMPACT PHASED ARRAY MILLIMETER WAVE COMMUNICATIONS SYSTEMS SUITABLE FOR FIXED WIRELESS ACCESS APPLICATIONS

(71) Applicant: CommScope Technologies LLC, Hickory, NC (US)

(72) Inventors: Michael BROBSTON, Allen, TX (US); Breck LOVINGGOOD, Wylie, TX (US); Dov EVEN, Dallas, TX (US); Huan WANG, Richardson, TX (US)

(21) Appl. No.: 16/770,658

(22) PCT Filed: Dec. 4, 2018
(86) PCT No.: PCT/US2018/063716

§ 371 Date: Jun. 8, 2020

Related U.S. Application Data
(60) Provisional application No. 62/611,594, filed on Dec. 29, 2017.

(30) Foreign Application Priority Data
Dec. 29, 2017 (US) 62611594

(51) Int. Cl. H01Q 21/00; H01Q 1/52; H01Q 1/22; H01Q 21/06; H01Q 3/36; H01P 1/211; H01P 5/16

(52) U.S. Cl. CPC H01Q 21/0025; H01Q 1/523; H01Q 21/0075; H01P 5/16; H01Q 21/065; H01Q 3/36; H01P 1/211; H01Q 1/2283

(57) ABSTRACT

Millimeter wave communications system include an RF printed circuit board structure that includes a phased array antenna that has a plurality of radiating elements and a channel block that includes a plurality of active antenna channels that each feed a respective one of a plurality of sub-groups of the radiating elements. A first sub-set of the active antenna channels are completely positioned on a first side of the phased array antenna and a second sub-set of the active antenna channels each include a first portion that is on a second side of the phased array antenna, the second side being adjacent the first side.

### FIELD

The present invention relates to communications systems and, more particularly, to communications systems that use phased array antennas.

### BACKGROUND

Wireless radio frequency (“RF”) communications systems, such as cellular communications systems, WiFi networks, microwave backhaul systems and the like, are well known in the art. Some of these systems, such as cellular communication systems, operate in the “licensed” frequency spectrum where use of the frequency band is regulated so that only specific users in any given geographical region can operate in selected portions of the frequency band to avoid interference. Other systems such as WiFi operate in the “unlicensed” frequency spectrum which is available to all users, albeit typically with limits on transmit power to reduce interference.

Cellular communications systems are now widely deployed. In a typical cellular communications system, a geographic area is divided into a series of regions that are referred to as “cells,” and each cell is served by a base station. The base station may include baseband equipment, radios and antennas that are configured to provide two-way RF communications with fixed and mobile subscribers that are positioned throughout the cell. The base station antennas generate radiation beams (“antenna beams”) that are directed outwardly to serve the entire cell or a portion thereof. Typically, a base station antenna includes one or more phase-controlled arrays of radiating elements, which are commonly referred to as phased array antennas.

There has been a rapid increase in the demand for wireless communications, with many new applications being proposed in which wireless communications will replace communications that were previously carried over copper or fiber optic communications cables. Conventionally, most wireless communications systems operate at frequencies below 6.0 GHz, with some exceptions such as microwave backhaul systems and various military applications. As capacity requirements continue to increase, the use of higher frequencies is being considered for various applications, including frequencies in both the licensed and unlicensed spectrum. As higher frequencies are considered, the millimeter wave spectrum, which includes frequencies from approximately 25 GHz to as high as about 300 GHz, is a potential candidate, as there are large contiguous frequency bands in this frequency range that are potentially available for new applications. The use of cellular technology has also been contemplated for so-called “fixed wireless access” applications such as connecting cable television or other optical fiber, coaxial cable or hybrid coaxial cable-fiber optic broadband networks to individual subscriber premises over wireless “drop” links. There currently is interest in potentially deploying communications systems that operate in the 28 GHz to 60 GHz (or even higher) frequency range for such fixed wireless access applications using fifth generation (“5G”) cellular communications technology.

For many 5G cellular communications systems, full two dimensional beam-steering is being considered. These 5G cellular communications systems may be time division multiplexed systems where different users or sets of users may be served during different time slots. For example, each 10 millisecond period (or some other small period of time) may represent a “frame” that is further divided into dozens or hundreds of individual time slots. Each user may be assigned one or more of the time slots and the base station may be configured to communicate with different users during their individual time slots of each frame. With full two dimensional beam-steering, the base station antenna may generate small, highly-focused antenna beams on a time slot-by-time slot basis as opposed to a constant antenna beam that covers a full sector. These highly-focused antenna beams are often referred to as “pencil beams,” and the base station antenna adapts or “steers” the pencil beam so that it points at different users during each respective time slot. Pencil beams may have very high gains and reduced interference with neighboring cells, so they may provide significantly enhanced performance.

In order to generate pencil beams that are narrowed in both the azimuth and elevation planes, it is typically necessary to provide antennas having a two-dimensional array that includes multiple rows and columns of radiating elements. The antennas may be active antennas that have independent amplitude and/or phase control for each radiating element in the planar array (or for individual sub-groups of radiating elements). Such independent control of the amplitude and/or phase of the sub-components of an RF signal that are transmitted (and received) by each radiating element allows the radiating elements to act in coordinated fashion to generate directional pencil beam radiation patterns that may be pointed at individual users. While this technique can provide very high throughput, the provision of planar array antennas having large numbers of radiating elements with associated electronics that provide for independent amplitude and phase control may add a significant level of cost and complexity to the communications system.

### SUMMARY

Pursuant to some embodiments of the present invention, millimeter wave communications systems are provided that include an RF printed circuit board structure that includes (1) a phased array antenna that includes a plurality of radiating elements and (2) a channel block that includes a plurality of active antenna channels that each feed a respective one of a plurality of sub-groups of the radiating elements. A first sub-set of the active antenna channels are completely positioned on a first side of the phased array antenna and a second sub-set of the active antenna channels each include a first portion that is on a second side of the phased array antenna, the second side being adjacent the first side.

In some embodiments, the second sub-set of the active antenna channels may include a total of one active antenna channel. In other embodiments, the second sub-set of the active antenna channels may include no more than two active antenna channels.

In some embodiments, second portions of all of the active antenna channels may extend generally in the same direction.

In some embodiments, the radiating elements may be arranged in rows and columns, and each active antenna channel may be connected to a respective one of the columns of radiating elements.

In some embodiments, each active antenna channel may include a high power amplifier and a low noise amplifier, and the high power amplifier and the low noise amplifier of a first of the active antenna channels are positioned closer to the phased array antenna than are the high power amplifier and the low noise amplifier of the second of the active antenna channels.

Pursuant to further embodiments of the present invention, power couplers for millimeter wave communications systems are provided that include a first 1×2 power coupler having a first input, first output and a second output, a second 1×2 power coupler having a second input that is coupled to the first output by a first transmission line segment, and a third 1×2 power coupler having a third input that is coupled to the second output by a second transmission line segment. The first transmission line segment includes a meandered delay line.

In some embodiments, these power couplers may further include a fourth 1×2 power coupler having a fourth input and a fifth 1×2 power coupler having a fifth input. In such embodiments, the second 1×2 power coupler may have a third output that is coupled to the fourth input by a third transmission line and a fourth output that is coupled to the fifth input by a fourth transmission line, where the third transmission line is longer than the fourth transmission line.

In some embodiments, the meandered delay line may comprise a co-planar waveguide meandered delay line and at least another portion of the first transmission line segment may comprise a microstrip transmission line segment.

In some embodiments, the first second and third 1×2 power couplers may each comprise a Wilkinson power coupler.

Pursuant to still further embodiments of the present invention, millimeter wave communications systems are provided that include a baseplate, an RF printed circuit board structure mounted on the baseplate, and an EMI shield cover mounted on the RF printed circuit board structure opposite the baseplate. The RF printed circuit board structure includes a phased array antenna and a plurality of active antenna channels formed therein, and the EMI shield cover includes at least a first cavity that covers a first portion of a first of the active antenna channels and a separate second cavity that covers a second portion of the first of the active antenna channels.

In some embodiments, the EMI shield cover may include downwardly extending walls that contact the RF printed circuit board structure, and respective lines of conductive vias may be formed in the RF printed circuit board structure underneath at least some of the downwardly extending walls of the EMI shield cover.

In some embodiments, a first integrated circuit chip amplifier may be mounted on the RF printed circuit board structure within the first cavity and a second integrated circuit chip amplifier may be mounted on the RF printed circuit board structure within the second cavity.

In some embodiments, a window may be provided between the first cavity and the second cavity.

Pursuant to yet additional embodiments of the present invention, millimeter wave communications systems are provided that include an RF printed circuit board structure, a first integrated circuit chip mounted on the RF printed circuit board structure, a second integrated circuit chip mounted on the RF printed circuit board structure, and an RF transmission line extending between the first and second integrated circuit chips. The RF transmission line includes a first co-planar waveguide transmission line segment adjacent the first integrated circuit chip and a microstrip transmission line segment that is between the first co-planar waveguide transmission line segment and the second integrated circuit chip.

In some embodiments, the RF transmission line may further include a second co-planar waveguide transmission line segment between the microstrip transmission line segment and the second integrated circuit chip.

Pursuant to still further embodiments of the present invention, substrate integrated waveguide filters are provided that include a printed circuit board comprising a dielectric substrate, a first metal layer on a top surface of the dielectric substrate that defines a top surface of the substrate integrated waveguide filter, a second metal layer on a bottom surface of the dielectric substrate that defines a bottom surface of the substrate integrated waveguide filter, a set of first conductive vias, each of the first conductive vias extending through the printed circuit board, the first conductive vias defining a first sidewall of the substrate integrated waveguide filter, a set of second conductive vias, each of the second conductive vias extending through the printed circuit board, the second conductive vias defining a second sidewall of the substrate integrated waveguide filter, and a set of third conductive vias that are between the first conductive vias and the second conductive vias, the third conductive vias dividing an interior of the substrate integrated waveguide filter into at least two cavities. A plurality of air-filled openings extend through the first metal layer, the dielectric substrate and the second metal layer, the air-filled openings extending through an interior of the substrate integrated waveguide filter.

In some embodiments, the substrate integrated waveguide filter may further include a co-planar waveguide to substrate integrated waveguide transition.

### BRIEF DESCRIPTION OF THE DRAWINGS

FIG. 1 is a schematic diagram illustrating an architecture in which a millimeter wave communications system is used in a fixed wireless access application.

FIG. 2 is a schematic diagram of a radio unit of the millimeter wave communications system of FIG. 1.

FIG. 3 is a schematic top view of a digital board of the radio unit of FIG. 2.

FIG. 4A is a schematic top view of an RF board of the radio unit of FIG. 2.

FIG. 413 is a cross-section taken along lines 4B-4B of FIG. 4A

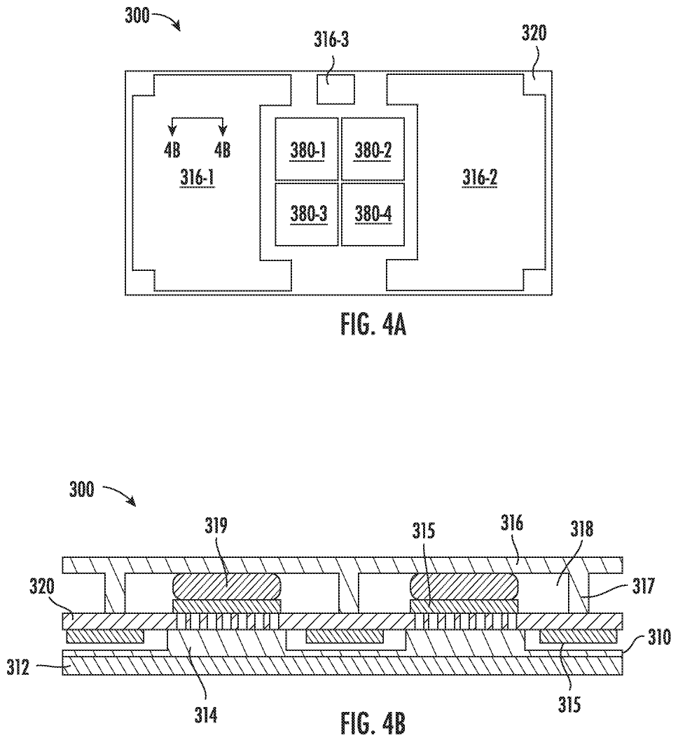

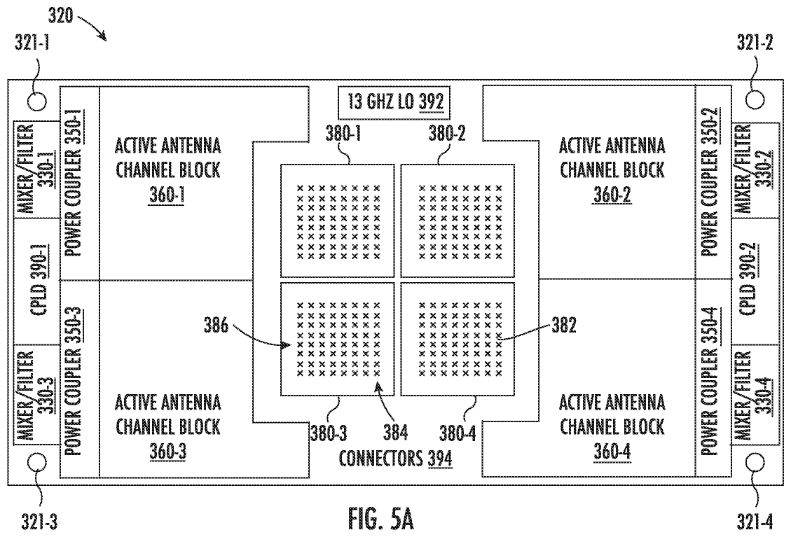

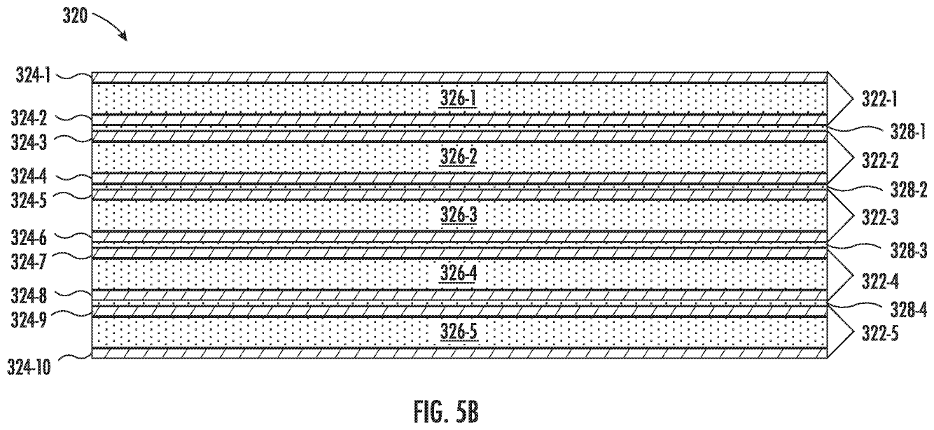

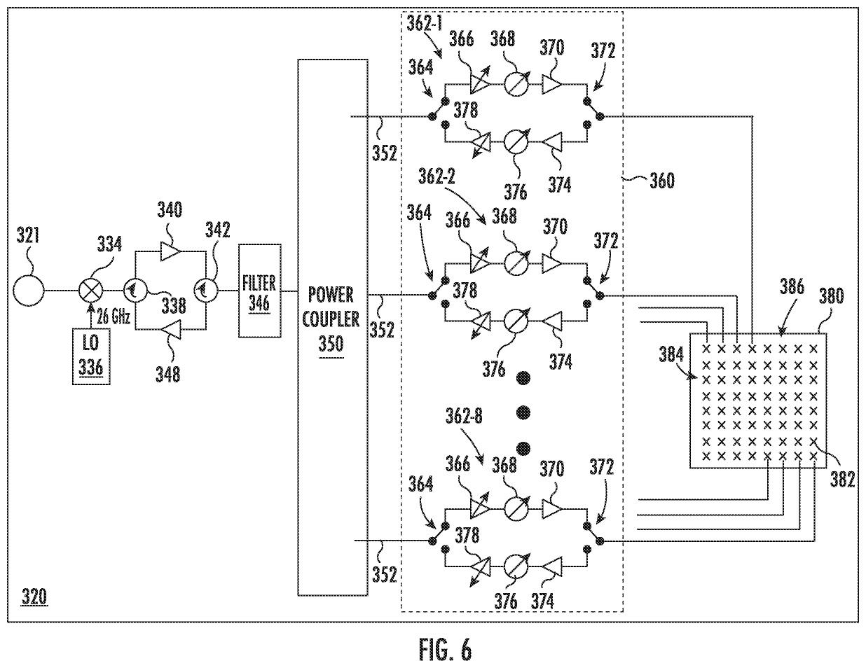

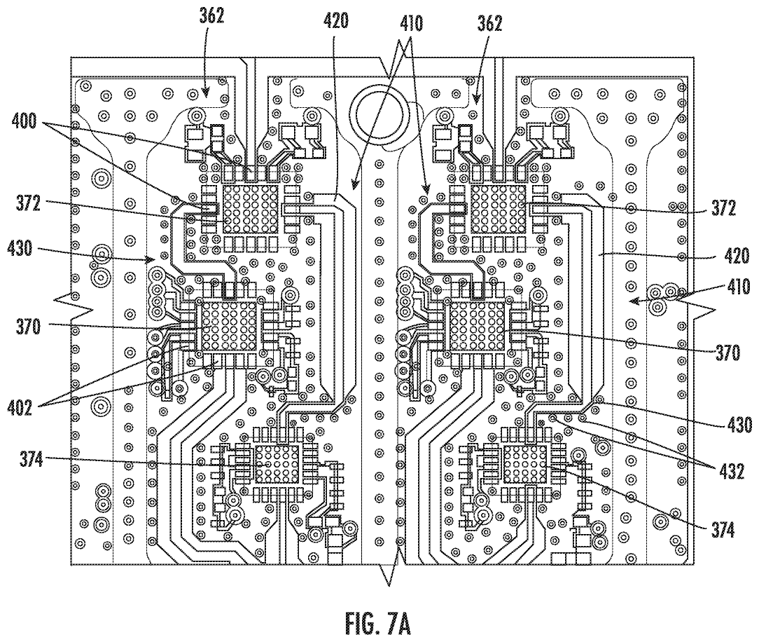

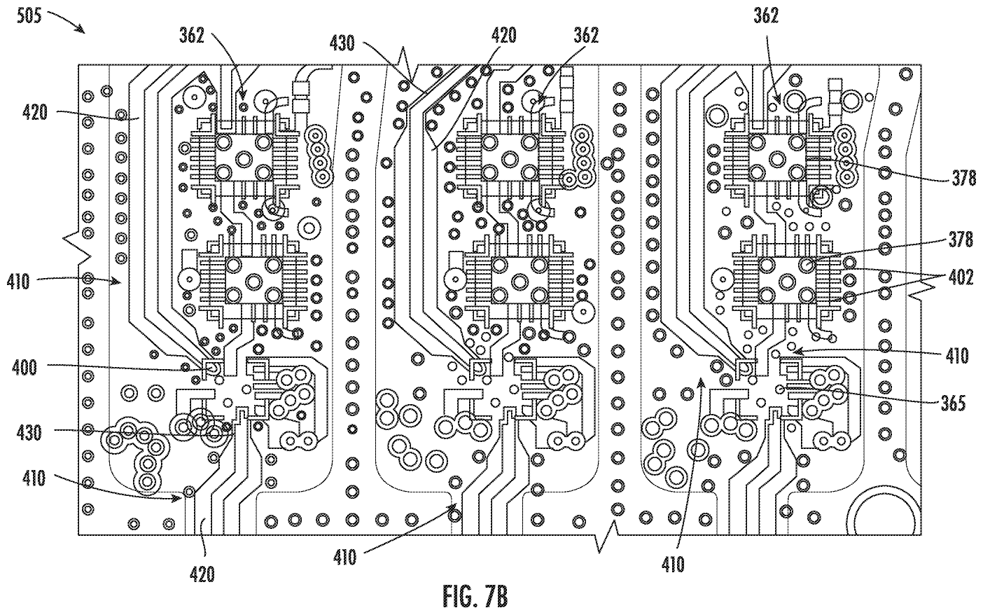

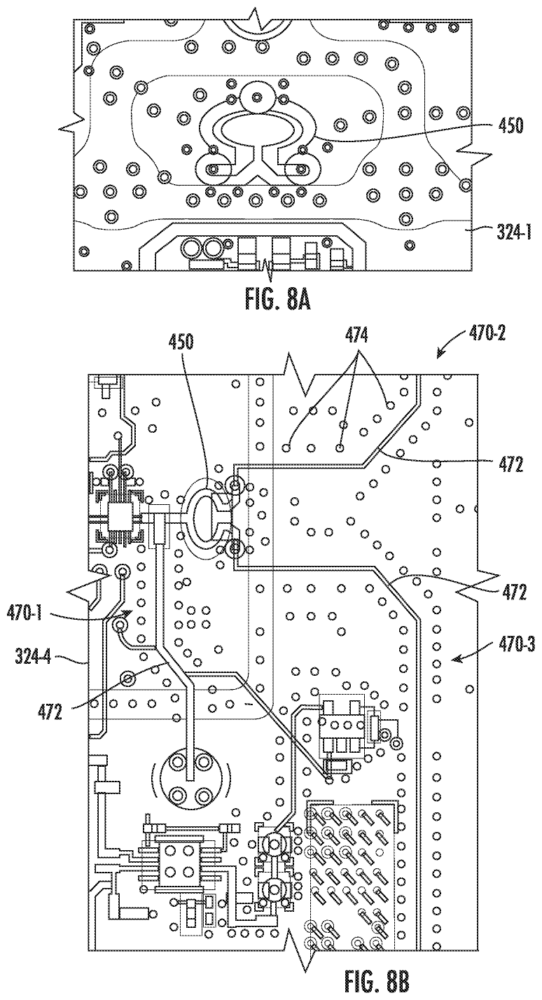

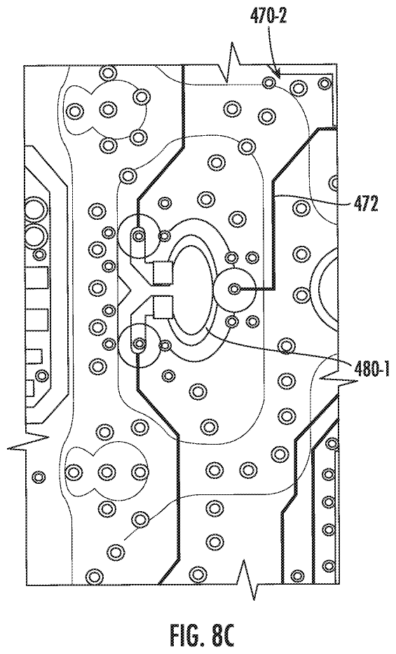

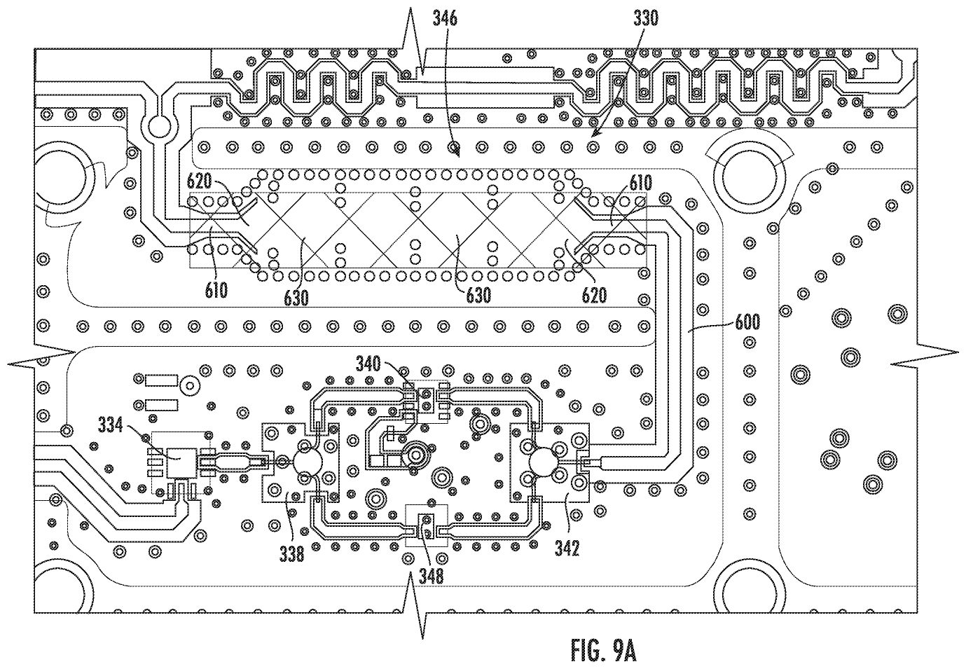

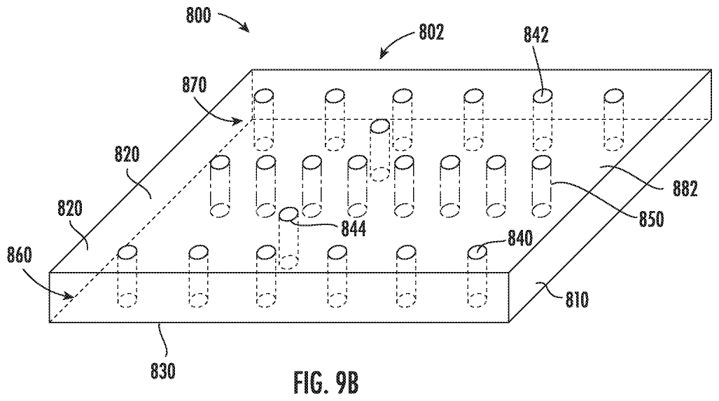

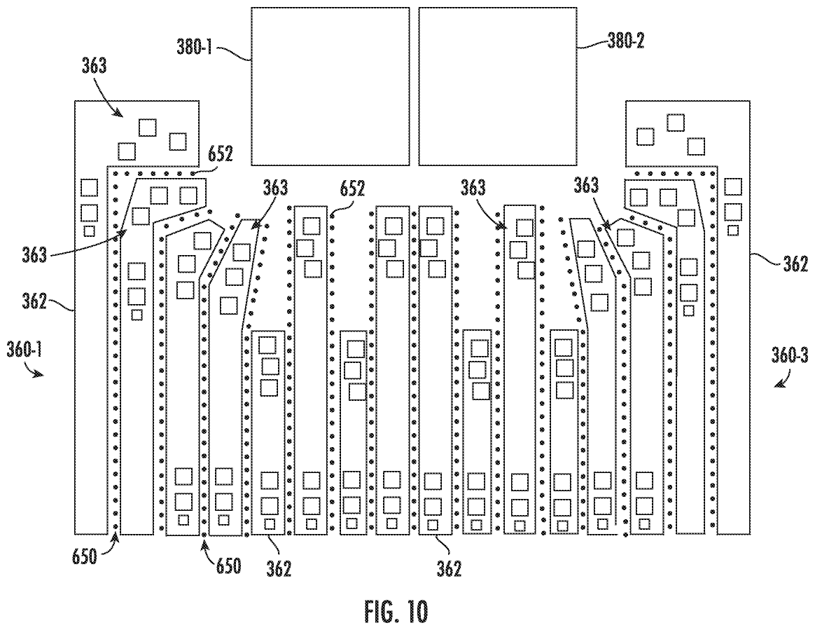

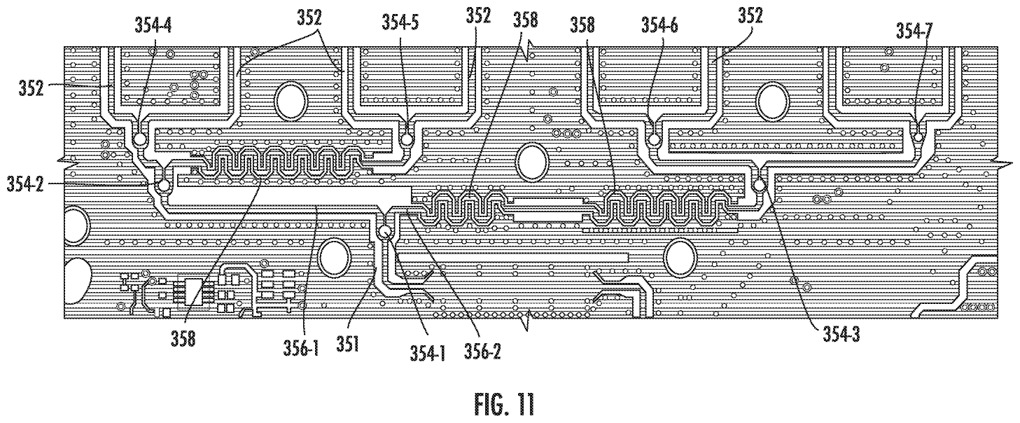

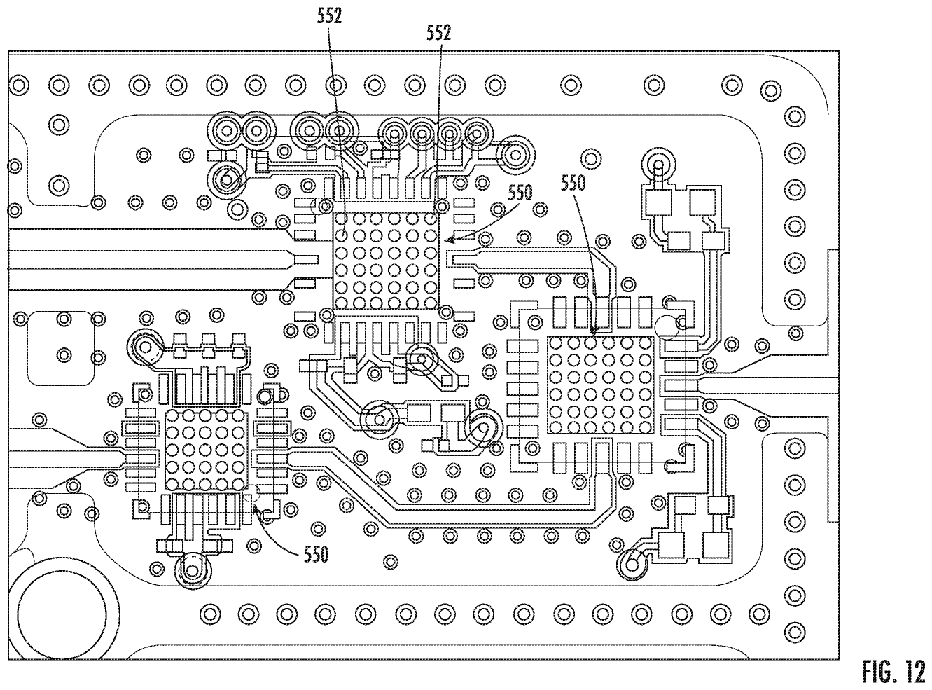

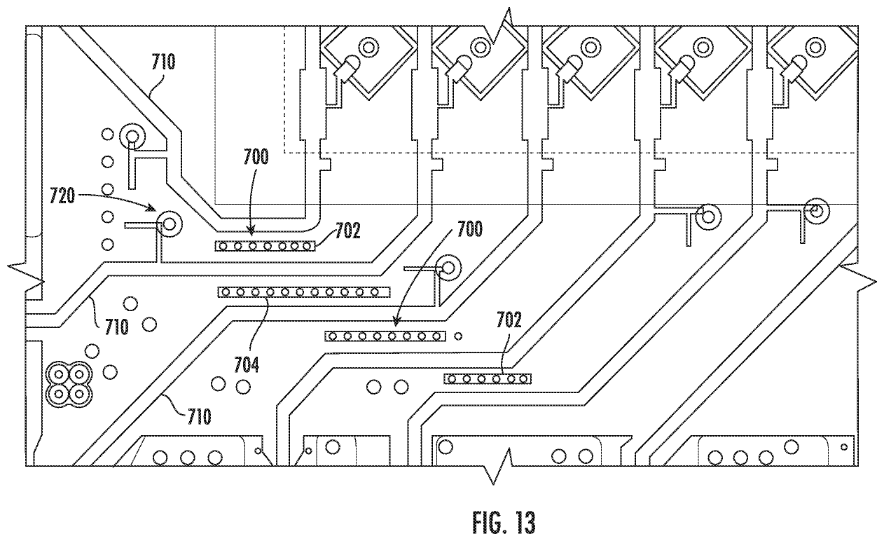

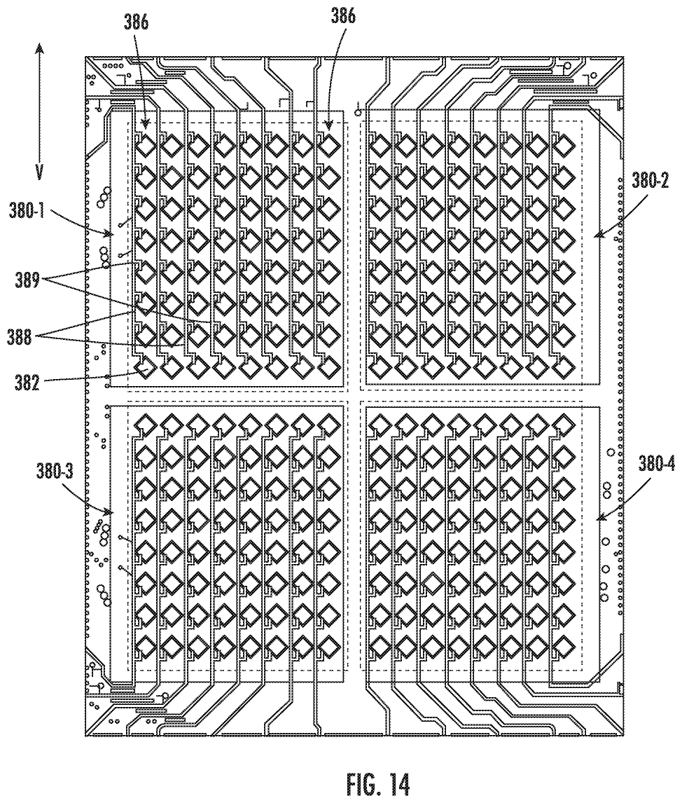

FIG. 5A is a schematic top view of a printed circuit board structure of the RF board of FIGS. 4A-4B.

FIG. 5B is a schematic side view of the printed circuit board structure of FIG. 5A.

FIG. 6 is a schematic block diagram of the RF transmission paths between one of the ports and one of the phased array antennas on the printed circuit board structure of FIGS. 5A-5B.

FIGS. 7A and 7B are enlarged views of portions of an example implementation of the printed circuit board structure of FIGS. 5A-5B that show transmission lines that include both microstrip and coplanar waveguide transmission line segments that reduce transmission line loss while maintaining low voltage standing wave ratio transitions to the integrated circuit chip pads.

FIGS. 8A through 8C are enlarged views of portions of the first and fourth layers of an example implementation of the printed circuit board structure of FIGS. 5A-5B that illustrate portions of a local oscillator distribution network thereof.

FIG. 9A is an enlarged view of a portion of an example implementation of one of the bidirectional mixer/filter blocks the printed circuit board structure of FIGS. 5A-5B.

FIG. 9B is a schematic diagram illustrating a portion of a substrate integrated waveguide filter that includes air-filled holes that reduce the dielectric loss of the filter.

FIG. 10 is a plan view of a portion of an example implementation of the printed circuit board structure of FIGS. 5A-5B that illustrates the staggered placement of the front-end sections of the active antenna channels and how the active antenna channels may wrap around the sides of the phased array antennas in order to reduce the overall width of the printed circuit board structure.

FIG. 11 is a plan view of a portion of an example implementation of the printed circuit board structure of FIGS. 5A-5B that illustrates the use of power couplers having meandered delay lines and asymmetric splits.

FIG. 12 is a plan view of an example implementation of the printed circuit board structure of FIGS. 5A-5B illustrating heat sink structures that are included therein to dissipate heat generated in the integrated circuit chips.

FIG. 13 is a plan view of a portion of an example implementation of the printed circuit board structure of FIGS. 5A-5B that illustrates via fence structures and DC bias coupling circuits that are implemented therein.

FIG. 14 is a plan view of an example implementation of the four phased array antennas included in the printed circuit board structure of FIGS. 5A-5B.

### DETAILED DESCRIPTION

Pursuant to embodiments of the present invention, millimeter wave communications systems are provided that have compact, high performance radio units. In some embodiments, the radio units include a plurality of phased array antennas that are configured to perform beamforming and operate as multi-input-multi-output (“MIMO”) antennas that simultaneously transmit multiple data streams to users. The millimeter wave communications systems according to embodiments of the present invention may be suitable for fixed wireless access applications and may support very high throughput communications at a reasonable cost.

Fixed wireless access applications refer to applications where the transmitters and receivers are at known, fixed locations. One proposed fixed wireless application is as a so-called “wireless drop” network that may be used as the last “leg” of a cable television network. Cable television networks are point-to-multipoint networks in which cable television, digital telephone, broadband Internet and/or other signals are transmitted between a headend facilities of a network operator/service provider and individual homes, apartment complexes, hotels, businesses, schools, government facilities and other subscriber premises (i.e., the physical locations of the subscribers to the network). These networks typically support two-way communications. In particular, “downstream” signals are transmitted from the headend facilities to the individual subscriber premises, and “upstream” signals are transmitted from the individual subscriber premises to the headend facilities. In a typical configuration, the downstream signals are transmitted over fiber optic cables to distribution points within individual neighborhoods where the optical signals are converted to radio frequency (“RF”) signals and distributed to individual subscriber premises over coaxial cable connections that typically run down individual streets. RF tap units are interposed along these coaxial cables, usually within an enclosure such as a pedestal. Each tap unit includes an input port and an output port that connect to respective first and second segments of the coaxial cable connection that runs down the neighborhood street, as well as one or more “tap ports.” The tap unit splits the RF signal that is received at an input port thereof, allowing some of the received signal energy to pass through the tap unit to the output port. The remainder of the received signal energy is split further and provided to the RF tap ports of the tap unit. So-called “drop” cables, such as, for example, coaxial drop cables, may run between each tap port of a tap unit and a point-of-entry device at each respective subscriber premise to connect each subscriber premise to the cable television network.

The drop cables that connect the cable television network to individual subscriber premises may be one of the most expensive parts of the outside plant of a cable television network, in terms of both initial installation and ongoing maintenance costs. In order to install a new drop cable, it is typically necessary for the service provider to send an installation crew to the site, equipped with cable burying equipment that can bury a drop cable as it is deployed and route the drop cable underneath driveways, sidewalks, fences and other pre-existing structures that are between the pedestal that houses the tap unit and a point of entry device at the subscriber premise. As the drop cables are almost always installed on privately owned real estate, it may be necessary to obtain easements before installation and to deal with complaints from property owners regarding damage to their lawns and/or shrubbery after installation is completed. The coaxial cable required for each drop may be expensive, as relatively long coaxial cable segments are typically required (e.g., 100-200 feet or more), and each coaxial cable segment only serves a single subscriber premise. Moreover, the buried coaxial cable is typically not installed in a protective conduit and hence has a limited lifetime, and also is susceptible to damage by private property owners digging on their properties to plant trees, install sprinkler systems, lay sod and the like.

Pursuant to embodiments of the present invention, millimeter wave wireless drop systems are provided that may be used in lieu of conventional drop cables. The wireless drop systems according to embodiments of the present invention may, in some embodiments, comprise one or more radio units that are mounted on a pole, pedestal, tower or other raised structure. Each radio unit may include one or more phased array antennas and associated electronics. In a typical implementation, three radio units may be mounted on the raised structure, with each radio unit serving a 120 degree sector in the azimuth plane in a manner similar to a sectorized cellular base station. Each radio unit may have a range of, for example, about 200-300 meters and may serve as the network gateway for a relatively large number of subscriber premises (e.g., up to 40-80 subscriber premises).

In an example embodiment, the millimeter wave wireless drop system may operate in the 28 GHz frequency band. The phased array antennas may be configured as beamforming antennas that can form relatively compact “pencil” antenna beams that are aimed at individual subscriber premises. These narrow antenna beams may have high levels of antenna gain, which helps offset the large free space loss that is incurred at millimeter wave frequencies. The system may be implemented as a time division multiplexed system in which the radio unit communicates with different subscribers during different time slots. The system may be a time division duplexed system where the downstream and upstream communications between the radio unit and each subscriber premise are transmitted in the same frequency band during different time slots. In some embodiments, each radio unit may include multiple phased array antennas in order to allow the radio unit to use multi-input-multi-output (“MIMO”) communications techniques. In an example embodiment each radio unit may include four phased array antennas and may transmit downstream signals to the subscriber premises using 4×MIMO techniques.

The radio units according to embodiments of the present invention may include a digital unit and an RF unit. Each of these units may be implemented as a multilayer printed circuit board structure. Integrated circuit chips such as controllers, optical-to-electrical, electrical-to-optical, digital-to-analog and analog-to-digital converters, power amplifiers, local oscillators, switches, diodes and the like may be mounted on the printed circuit board structures. The phased array antennas may also be implemented as part of the RF printed circuit board structure.

Embodiments of the present invention will now be discussed in further detail with reference to the attached drawings.

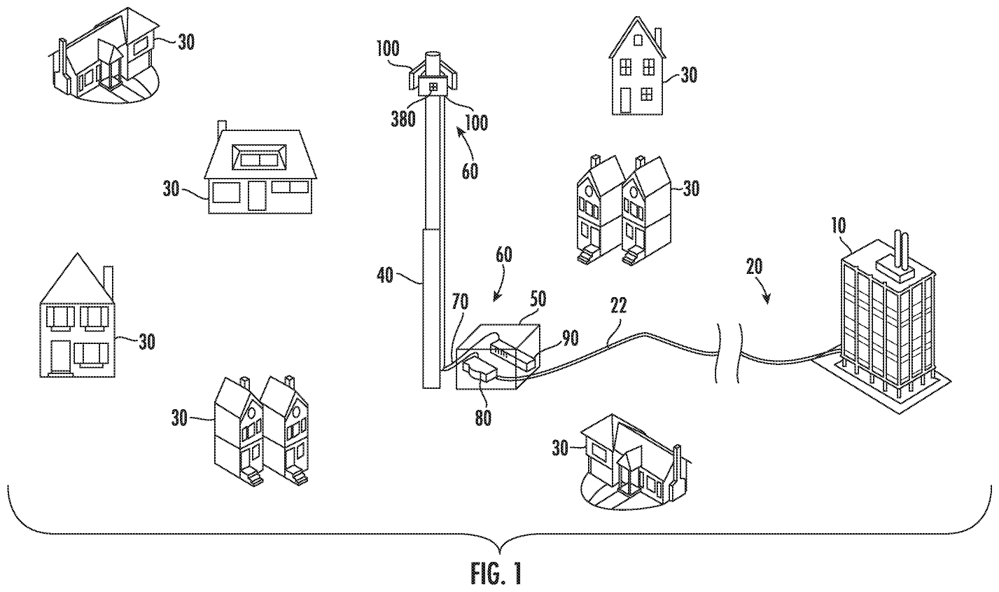

FIG. 1 is a schematic diagram illustrating an architecture in which a millimeter wave communications system is used in a fixed wireless access application. As shown in FIG. 1, a core fiber optic network 20 may connect head end facilities 10 of a network provider to individual neighborhoods and other locations. In each neighborhood, one or more millimeter wave communications systems 60 may be installed that provide wireless connections between the core fiber optic network 20 and individual subscriber premises 30 such as homes, apartments, office buildings and the like. Each millimeter wave communications system 60 may comprise one or more baseband units 80, a power supply 90 and one or more radio units 100. In the example of FIG. 1, a baseband unit 80 and a power supply 90 are mounted in a cabinet 50 near the base of a raised structure 40 such as, for example, a utility pole 40. Three radio units 100 are shown mounted on the utility pole 40 with the phased array antennas 380 of each radio unit 100 pointed outwardly to serve a 120 degree “sector” in the azimuth plane (i.e., in a plane parallel to the plane defined by the horizon). Each radio unit 100 may transmit downstream signals to the subscriber premises 30 and receive upstream communications from the subscriber premises 30 in order to allow each subscriber premise 30 access to the core fiber optic network 20. The baseband equipment 80 and power supply 90 may be connected to the radio units 100 by one or more cables 70 such as fiber optic and power cables. Thus, the millimeter wave communications system 60 may comprise the cables 70, the baseband unit 80, the power supply 90 and the radio units 100.

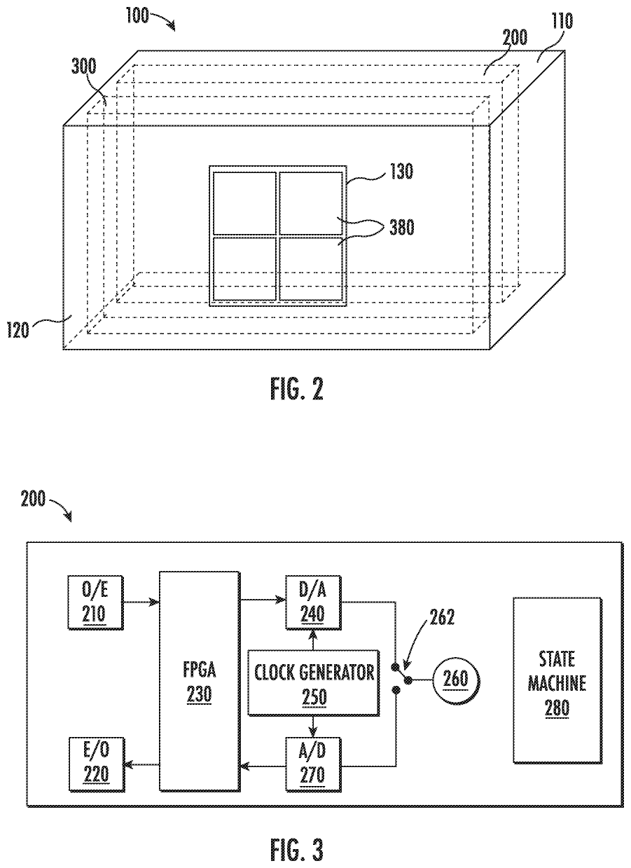

FIG. 2 is a schematic diagram of one of the radio units 100 of the millimeter wave communications system 60 of FIG. 1. As shown in FIG. 2, the radio unit 100 includes a housing 110 that has a digital unit in the form of a digital board 200 and an RF unit in the form of an RF board 300 mounted therein. The housing 110 may comprise a metal housing and may have a removable front cover 120 that allows the digital board 200 and the RF board 300 to be installed within the housing 110. The front cover 120 may include an opening 130 that is aligned with phased array antennas 380 (discussed below) that are included on the RF board 300 so that the phased array antennas 380 may transmit signals to, and receive signals from, the subscriber premises 30 without the front cover 120 blocking or otherwise interfering with such signals. A radome (not shown) may be provided that covers the opening 130 to protect the RF board 300 and the digital board 200 from the environment (e.g., rain, snow, insects, birds, etc.). The digital board 200 and the RF board 300 may be mounted back-to-back in the housing 110, with the RF board 300 in front so that the phased array antennas 380 are facing outwardly. A plurality of connectors and/or connectorized cables (not shown) may be used to electrically connect the digital board 200 to the RF board 300.

FIG. 3 is a schematic top view of a digital board 200 of the radio unit 100 of FIG. 2. As discussed above with reference to FIG. 1, the millimeter wave communications system 60 includes a baseband unit 80 that may be mounted, for example, at the bottom of the utility pole 40. The baseband unit 80 is connected to the core fiber optic network 20 by a back-haul fiber optic cable 22. A front-haul fiber optic cable 70 connects the baseband unit 80 to the digital board 200. The front-haul fiber optic cable 70 may include a plurality of optical fibers. Assuming that separate optical fibers are provided for the uplink and the downlink, then the downlink optical fibers may be connected to optical-to-electrical modules 210 and the uplink optical fibers may be connected to electrical-to-optical modules 220. The optical-to-electrical modules 210 may convert the fiber optic data received over the front-haul fiber optic cable 70 into 100 MHz digital baseband data. The outputs of the optical-to-electrical modules 210 may be connected to a field programmable gate array (“FPGA”) 230 that depacketizes the digital data and strips formatting therefrom. An output of the field programmable gate array 230 is connected to a digital-to-analog converter 240. The digital-to-analog converter 240 converts the digital data stream that is received from the field programmable gate array 230 into an analog signal. The digital-to-analog converter 240 receives a clock signal from a clock generator 250 that is used to sample the analog data to produce an intermediate frequency such as 2 GHz. The 2 GHz signal is passed from the digital-to-analog converter 240 to a first transmit/receive switch 262. The first transmit/receive switch 262 is provided to allow the radio unit 100 to operate as a time division duplexed system where different time slots are used for transmitting and receiving signals. The first transmit/receive switch 262 may be set either to feed a signal from the digital-to-analog converter 240 to a connector 260 that connects to the RF board 300 or to feed signals received at the connector 260 to an analog-to-digital converter 270.

Signals received by the RF board 300 are passed to the digital board 200 through the connector 260. The received signal is passed to the analog-to-digital converter 270 that samples the 2 GHz signal to produce an image in the first Nyquist zone (using the clock signal from the clock generator 250). The analog-to-digital converter 270 then digitizes the baseband signal. The digital baseband signal is passed to the field programmable gate array 230 which formats and packetizes the digital data. The data is then passed to an electrical-to-optical converter 220 that converts the digital data into an optical signal that is passed to the baseband unit 80 over the front-haul cable 70. While not shown in FIG. 3, the above-described components of the digital board 200 may be replicated three additional times so that four separate 2 GHz signals may be passed simultaneously between the digital board 200 and the RF board 300. The digital board 200 may further include a state machine or other controller 280 that generates control signals that are used to control components on the RF board 300.

FIG. 4A is a schematic top view of the RF board 300 of FIG. 2. FIG. 4B is a schematic cross-section taken along line 4B-4B of FIG. 4A. As shown in FIGS. 4A-4B, the RF board 300 includes a baseplate 310, a multi-piece EMI shield cover 316 and a multilayer printed circuit board structure 320. The baseplate 310 acts as a mounting structure for the printed circuit board structure 320, providing rigidity to RF board 300 and providing protection for the printed circuit board structure 320 and the integrated circuit chips mounted thereon. The baseplate 310 includes an integrated vapor chamber 312 on a lower surface thereof. Vapor in the vapor chamber 312 conducts heat away from the printed circuit board structure 320 to vent the heat from the RF board 300. The vapor chamber 312 may have a very high thermal conductivity so as to provide a very low resistance thermal path for venting heat away from the RF board 300. The baseplate 310 may include a peripheral lip (not visible in the figures) that directly contacts and supports the bottom side of the printed circuit board structure 320. The baseplate 310 may also include a plurality of pedestals 314 that provide additional support to the printed circuit board structure 320 and which serve as low resistance thermal paths for venting heat away from the printed circuit board 320. The pedestals 314 may be located directly underneath various high power integrated circuit chips 315 to facilitate venting heat generated by these devices. The baseplate 310 may comprise a high strength material having good thermal conductivity such as, for example, aluminum. Additional integrated circuit chips 315 may be mounted on the lower surface of the printed circuit board structure 320.

The EMI shield cover 316 may comprise a metal or metal-containing structure that is used to reduce leakage of RF energy from the printed circuit board structure 320 and to block RF energy from external sources from coupling to the printed circuit board structure 320, where such RF energy may appear as interference. By reducing leakage of RF energy, the EMI shield cover 316 may also reduce coupling between different active antenna channels on the printed circuit board structure 320. The EMI shield cover 316 may comprise, for example, a cast or machined aluminum shield cover 320. The EMI shield cover 316 may have a flat top surface and a plurality of downwardly-extending walls 317 that define a plurality of cavities 318 in a lower surface thereof. In the depicted embodiment, a total of three EMI shield covers 316-1 through 316-3 are provided (see FIG. 4A). It will be appreciated, however, that more or fewer EMI shield covers 316 may be used in other embodiments. The multilayer printed circuit board structure 320 is sandwiched between the baseplate 310 and the EMI shield covers 316, as shown in FIG. 4B. As is further shown in FIG. 4A, four phased array antennas 380-1 through 380-4 are formed in the top layers of the printed circuit board structure 300.

Thermal gaskets 319 may be placed on top of the high power integrated circuit chips 315, such as the power amplifier chips, so that the thermal gaskets 319 are between the integrated circuit chips 315 and the EMI shield cover 316. The thermal gaskets 319 may be compressed as the EMI shield cover 316 is attached to the printed circuit board structure 320. The thermal gaskets 319 may facilitate conducting heat from the top surface of the integrated circuit chips 315 to the EMI shield cover 316.

FIGS. 5A-5B are schematic views that illustrate the multilayer printed circuit board structure 320 in greater detail. In particular, FIG. 5A is a schematic top view of the printed circuit board structure 320 that illustrates the layout of the top metallization layer thereof in greater detail, while FIG. 5B is a schematic side view that illustrates the layer structure of the printed circuit board structure 320.

Referring first to FIG. 5B, the printed circuit board structure 320 comprises a multi-layer printed circuit board having ten metallization layers 324-1 through 324-10 that are separated by nine dielectric layers. As will be discussed in detail herein, surface mount components may be mounted on the top and bottom metallization layers 324-1 and 324-10. The dielectric layers include core dielectric layers 326-1 through 326-5 and adhesive dielectric layers 328-1 through 328-4. The core dielectric layers 326 may comprise standard printed circuit board materials such as, for example, Taconic TSM-DS3, FR4, Arlon AD3003A, or Rogers RO3003 printed circuit board substrate materials. The metallization layers 324 may be patterned metal layers that are formed on the top and bottom surfaces of the core dielectric layers 326 using, for example, conventional printed circuit board fabrication techniques. Thus, a total of five so-called “double-layer” printed circuit boards 322 (i.e., printed circuit boards that comprise a core dielectric layer 326 with metal layers 324 on each side thereof) may be used to form the printed circuit board structure 320. The adhesive dielectric layers 328 may be used to adhere adjacent ones of the double-layer printed circuit boards 322 together to form the multilayer printed circuit board structure 320. The adhesive dielectric layers 328 may comprise, for example, a “prepreg” material such as a fiberglass material or other composite fiber material that is pre-impregnated with a thermoset polymer matrix material (e.g., an epoxy resin) and a curing agent. The prepreg material becomes flowable when heated and then acts as an adhesive to bind the fibers together and to other components such as the printed circuit boards 322.

Referring now to the schematic view of FIG. 5A, the printed circuit board structure 320 includes four input/output ports 321-1 through 321-4. Each input/output port 321 may be connected to a respective one of the connectors 260 on the digital board 200 by, for example, a coaxial cable. A plurality of RF paths extend between each input/output port 321 and a respective one of the phased array antennas 380. Thus, the printed circuit board structure 320 may simultaneously transmit four different signals through the respective four phased array antennas 380. These four signals may be transmitted to a single user or to multiple users during any given time slot in the time division multiplexing frame structure. FIG. 5A is rotated ninety degrees from the orientation that the printed circuit board structure 320 will have when the printed circuit board structure 320 is mounted for normal use so that the figure may be enlarged on the page. Thus, it will be appreciated that the printed circuit board structure 320 will be rotated ninety degrees from this orientation when mounted for use.

Each transmit/receive path that extends from an input/output port 321 to a respective one of phased array antennas 380 includes a bidirectional mixer/filter block 330, a power coupler 350, and a channel group 360, each of which are implemented on the top metallization layer 324-1 of the printed circuit board structure 320.

Each bidirectional mixer/filter block 330 may include a mixer that performs up-conversion on intermediate frequency signals that are to be transmitted and that performs down-conversion (to an intermediate frequency) on received RF signals. This mixer is also referred to herein as an upconverter and/or as a downconverter. In an example embodiment, each mixer may be a subharmonic mixer that uses a 13 GHz local oscillator signal to up-convert 2 GHz intermediate frequency signals to 28 GHz for transmission and to down-convert received 28 GHz signals to 2 GHz. Each bidirectional mixer/filter block 330 also includes a bandpass filter that removes unwanted intermodulation products that are generated by the mixer as well as other out-of-band noise components. The design and operation of example embodiments of the mixers and filters will be discussed in greater detail below with reference to FIGS. 6 and 9A-9B.

Each power coupler 350 receives (for signals flowing in the transmit direction) the 28 GHz signal output by one of the bidirectional mixer/filter blocks 330 and splits this signal into eight separate sub-components. In some embodiments, the power coupler 350 may split the power of the 28 GHz signal into eight sub-components that have equal power, although embodiments of the present invention are not limited thereto. Each eight-way power coupler 350 may be implemented, for example, as a series of 1×2 power couplers that split an RF signal to be transmitted into eight sub-components that are passed to the eight columns 386 of an associated phased array antenna 380 and which combine eight sub-components of an RF signal received at the phased array antenna 380 into a composite received RF signal. The eight outputs of each power coupler 350 are coupled to a respective one of the channel groups 360. An example implementation of one of the power couplers 350 will be described in greater detail below with reference to FIG. 11.

Each channel group 360 passes the sub-components of an RF signal received from one of the power couplers 350 to one of the phased array antennas 380. Each channel group 360 includes eight active antenna channels 362. Each of the eight active antenna channels 362 included in a channel group 360 is connected to a respective one of the eight columns 386 of the phased array antennas 380. Each active antenna channel 362 receives the eight sub-components of the RF signal output by the power coupler 350, modifies the amplitude and/or phase of these signals for purposes of power balancing and beam steering in the azimuth plane, amplifies the sub-components and passes the amplified sub-components of the RF signal to a respective one of the columns 386 of the phased array antenna 380 for transmission. Thus, each active antenna channel 362 may be used to independently adjust the amplitude and/or phase of a respective sub-component of an RF signal. Operation of the channel groups 360 will be discussed in greater detail below with reference to FIG. 6.

Each phased array antenna 380 comprises an 8×8 array of radiating elements 382. In the depicted embodiment, each radiating element 382 may comprise a stacked patch radiating element. Each phased array antenna 380 may be implemented using any of the phased array antennas described in U.S. Provisional Patent Application Ser. No. 62/573,749, entitled Broadband Stacked Patch Radiating Elements and Related Phased Array Antennas, Attorney Docket No. 9833-1414-PR, filed Oct. 18, 2017, the content of which is incorporated herein by reference as if set forth in its entirety. As shown in FIG. 5A, each phased array antenna 380 includes sixty-four radiating elements 382 that are arranged in eight rows 384 and eight columns 386. Since, as noted above, the printed circuit board structure 320 is rotated ninety degrees in FIG. 5A, the columns 386 extend horizontally in FIG. 5A while the rows 384 extend vertically. The provision of eight radiating elements 382 in each row 384 and column 386 of the phased array antennas 380 allows the phased array antennas 380 to generate antenna beams that may be significantly narrowed in both the azimuth and elevation planes.

As noted above, each phased array antenna 380 is fed by eight active antenna channels 362. As will be discussed in greater detail below, an active antenna channel 362 is a channel that receives a sub-component of an RF signal that is to be transmitted (or a received sub-component of an RF signal) and passes the RF signal through an adjustable phase shifter and/or a component such as a variable attenuator that can adjust a magnitude of the RF signal so that each channel may independently adjust the magnitude and/or phase of the sub-component of an RF signal passed therethrough. Thus, the sub-components of an RF signal provided to each radiating element 382 in one of the rows 384 of radiating elements 382 in a first of the phased array antennas 380 may have an independently set magnitude and/or phase. This capability allows the phased array antenna 380 to steer the antenna beam in the azimuth plane.

While each row of each phased array antenna 380 is fed by a different active antenna channel 362, each column 386 of the phased array antenna 380 is fed by the same active antenna channel 362. Thus, each radiating element 382 in a given column 386 receives the same sub-component of the RF signal. Since the amplitudes and/or phases of the sub-component of the RF signal that are fed to each radiating element 382 in a column 386 are not independently adjustable, the phased array antenna 380 cannot perform beam steering in the elevation plane. Each phased array antenna 380, however, may be designed to have a switched elevation beamwidth. Techniques for implementing such elevation beamwidth switching are disclosed in U.S. Provisional Patent Application Ser. No. 62/506,100, entitled Phased Array Antennas Having Switched Elevation Beamwidths and Related Methods, Attorney Docket No. 9833-1221-PR, filed May 15, 2017, and in U.S. Provisional Patent Application Ser. No. 62/522,859, having the same title, Attorney Docket No. 9833-1221-PR2, filed on Jun. 21, 2017, the entire content of each of which is incorporated herein by reference as if set forth in its entirety.

As described in the above-identified applications, one or more switches such as, for example, PIN diodes, may be interposed along each transmission line that connects an active antenna channel 362 to the radiating elements 382 in a column 386 of a phased array antenna 380. When these switches are all in the OFF (high impedance) state, all of the radiating elements 382 in a column 386 are fed the sub-component of an RF signal, and the phased array antenna 380 may generate an antenna beam having a relatively narrow beamwidth in the elevation plane. Under these circumstances, the antenna beam may be pointed towards the far edge of the region (“cell”) covered by the phased array antenna 380. In contrast, when one of the switches is in the ON (low impedance) state, the radiating elements 382 along the column 386 that are after the switch are effectively removed from the column 386. When this occurs, the elevation beamwidth of the phased array antenna 380 is increased, allowing the phased array antenna 380 to generate an antenna beam that will cover subscribers that are closer to the radio unit 100 (i.e., not near the edge of the cell) or which are at greater elevation angles (e.g., subscribers in a multi-story building). While the gain of the antenna beam is reduced when elevation beamwidth switching is used to increase the elevation beamwidth, such elevation beamwidth switching is typically performed so that the antenna beam will cover subscribers that are closer to the radio unit 100, and hence experience less free space loss.

Finally, as further shown in FIG. 5A, the printed circuit board structure 320 includes first and second customizable programmable logic device (“CPLC”) circuits 390, a 13 GHz local oscillator (“LO”) synthesizer circuit 392, and DC power and control connectors 394.

The first and second customizable programmable logic device circuits 390 are also implemented on the bottom metallization layer 324-1 of printed circuit board structure 320. The customizable programmable logic device circuits 390 may be used to generate control signals that are passed to various integrated circuit chips 315 and other components mounted on the printed circuit board structure 320 such as, for example, variable attenuators, adjustable phase shifters, high power amplifiers, low noise amplifiers, switches and the like. Each customizable programmable logic device circuit 390 may decode control instructions received from the digital board 200 of the millimeter wave communications system 100 (via, for example, a high speed serial bus) and generate the control signals therefrom.

The 13 GHz local oscillator synthesizer circuit 392 is an integrated circuit chip that is mounted on the top metallization layer 324-1 of printed circuit board structure 320. The 13 GHz local oscillator synthesizer circuit 392 consists of a phase locked loop controlling a voltage oscillator that generates a 13 GHz signal that is phase locked to a local timing reference and that is used as a local oscillator signal by the mixers in the bidirectional mixer filter blocks 330 for purposes of generating the 26 GHz signals that are used for up-conversion and down-conversion. A 13 GHz local oscillator reference signal is used to avoid the need to generate a 26 GHz local oscillator reference signal due to the high losses that would be associated with distributing a 26 GHz local oscillator reference signal to the four bidirectional mixer/filter blocks 330 that are located near the four corners of the printed circuit board structure 320. The mixers may be implemented as sub-harmonic mixers that internally double a received local oscillator signal to convert the 13 GHz local oscillator signal into a 26 GHz signal.

DC power and control connectors 394 are mounted on the back side of the printed circuit board structure 320. The DC power and control connectors 394 may be connected to mating connectors on the digital board 200 to supply DC power and control signals to the RF board 300.

FIG. 6 is a block diagram of one of the bidirectional mixer/filter blocks 330, one of the power splitters 350, one of the channel groups 360, and one of the phased array antennas 380 of the printed circuit board structure 320 of FIGS. 5A-5B. As shown in FIG. 6, an intermediate frequency signal may be input to the printed circuit board structure 320 from the digital board 200 through an input/output port 321. The intermediate frequency signal may comprise, for example, a 2 GHz analog data signal. It will be appreciated, however, that any suitable intermediate frequency may be used, or that baseband data may be supplied to the printed circuit board structure 320 in other embodiments

The 2 GHz signal may be received at input/output port 321 via a cabling connection (not shown) from the connector 260 on the digital board 200. The 2 GHz signal is passed from input/output port 321 to an up/down converter 334 that multiplies the 2 GHz signal by a local oscillator signal to up-convert the 2 GHz signal. The up/down converter 334 may be fed by a local oscillator 336 that generates, for example, a 13 GHz signal. As noted above, the up/down converter 334 may double the 13 GHz local oscillator signal to generate a 26 GHz oscillation signal before multiplying the oscillation signal with the 2 GHz data signal to generate a 28 GHz transmit signal. This 28 GHz signal may be output by the up/down converter 334 to a first circulator 338 (or, alternatively, a transmit/receive switch). The first circulator 338 routes the 28 GHz signal to an amplifier 340 that increases the signal level to maintain an acceptable signal-to-noise ratio. The output of the amplifier 340 is fed to a second circulator 342 (or, alternatively, another transmit/receive switch) which feeds the signal to a filter 346.

With respect to upstream signals, RF signals received by the phased array antenna 380 may be passed from the filter 346 to the second circulator 342. The second circulator 342 passes such signals to a low noise amplifier 348. The low noise amplifier 348 increases the level of the received signal to maintain an acceptable signal-to-noise ratio. The received signal is then passed through the first circulator 338 to the up/down converter 334, which uses the local oscillator signal to downconvert the received signal to an intermediate frequency (e.g., 2.0 GHz). This downconverted signal is passed to the input/output port 321 where it is coupled to the digital board 200.

The filter 346 may comprise a bandpass filter that filters out intermodulation products and local oscillator leakage generated at the up/down converter 334 and any other unwanted signals or noise. For example, the filter 346 may comprise a 28 GHz bandpass filter. The filtered 28 GHz signal output by filter 346 is passed to one of the 1×8 power couplers 350. The power coupler 350 splits the RF signal that is to be transmitted into eight sub-components (which may or may not have equal amplitudes depending upon the design of the power coupler 350). Each sub-component is passed through an output leg 352 of power coupler 350 to a respective one of the active antenna channels 362 of the channel block 360.

Each active antenna channels 362 forms a transmit path and a receive path between one of the outputs 352 of power coupler 350 and one of the columns 386 of the phased array antenna 380. Each active antenna channels 362 includes a second transmit/receive switch 364 and a third transmit/receive switch 372 that are used to route signals along either a transmit path or a receive path. The transmit path includes a variable attenuator 366, a variable phase shifter 368 and a high power amplifier 370 that are arranged in series between the second transmit/receive switch 364 and the third transmit/receive switch 372. The variable attenuator 366 may be configured to reduce the magnitude of the sub-component of the RF signal supplied thereto by an amount determined by a control signal provided to the variable attenuator 366. The variable attenuator 366 may comprise, for example, a switched attenuator circuit that has a plurality of different selectable attenuation values. The variable phase shifter 368 may be used to modify the phase of the sub-component of the RF signal. The variable phase shifter 368 may comprise, for example, an integrated circuit chip that may adjust the phase of a millimeter wave signal input thereto. A control signal supplied to the variable phase shifter 368 may select one of a plurality of phase shifts. The high power amplifier 370 may amplify the sub-component of the RF signal to an appropriate transmit level. The amplified sub-component of the RF signal is then passed to a column 386 of the phased array antenna 380 for over the air transmission. A splitter/combiner network (not shown) may further split the RF signal to pass a portion thereof to some or all of the radiating elements 382 included in the column 386.

When operating in receive mode, a millimeter wave signal (e.g., a 28 GHz signal) may be received at some or all (depending upon the elevation beam switching mode) of the eight radiating elements 382 of the column 386 of the phased array antenna 380. The above-mentioned splitter/combiner network (not shown) may combine the sub-components of the received signal and pass the combined received signal through the third transmit/receive switch 372 to a receive path of the active antenna channel 362. The receive path includes a low noise amplifier 374, a variable phase shifter 376 and a variable attenuator 378. The low noise amplifier 374 amplifies the received signal and passes it to the adjustable phase shifter 376, which may adjust a phase of the received signal. The output of the variable phase shifter 376 is passed to the variable attenuator 378 that may be used to reduce the magnitude of the received signal. The output of the variable attenuator 378 is passed to the second transmit/receive switch 364, which passes the signal to the power coupler 350 which combines the RF signals received at each of the eight columns 386 of phased array antenna 380.

While the above discussion only describes one of the active antenna channels 362, it will be appreciated that the other active antenna channels 362 may operate in the same manner as discussed above. As will be discussed below, in some embodiments an RF integrated circuit beamforming chip may be used to implement the transmit path and receive path variable attenuators 366, 378 and phase shifters 368, 376 and the second transmit/receive switch 364.

The phased array antenna 380 is implemented as an 8×8 array of radiating elements 382. As the phased array antenna 380 has already been discussed in detail above (including in the co-pending provisional applications that have been incorporated herein by reference), further description thereof will be omitted here.

FIGS. 7A and 7B are enlarged views of two portions of an example implementation of the printed circuit board structure 320 of FIGS. 5A-5B that illustrate transmission lines that include both microstrip and coplanar waveguide transmission line segments that reduce transmission line loss while maintaining low voltage standing wave ratio transitions to integrated circuit chip pads. Referring first to FIG. 7A, an example implementation of portions of two of the active channel paths 362 are shown. FIG. 7A shows the “front end” portions of two of the active channel paths 362 (i.e., the portions of the active antenna channels 362 that are closest to the phased array antenna 380 along the RF transmission path). The front end portion of each active antenna channel 362 includes the third transmit/receive switch 372, the high power amplifier 370 and the low noise amplifier 374, each of which are implemented as an integrated circuit chip. Each integrated circuit chip 370, 372, 374 includes a number of RF input/output pads 400 around the periphery thereof that are used to input/output RF signals as well as input/output pads 402 for receiving power and control signals. Because of the narrow spacing between adjacent ones of these input/output pads 400, 402 it may not be possible to connect a conventional microstrip transmission line to the RF input/output pads 400, at least while using reasonably priced printed circuit board materials and transmission line widths suitable for obtaining good impedance matches between the transmission lines and the integrated circuit chips 370, 372, 374.

As shown in FIG. 7A, the RF transmission lines 410 that extend between the integrated circuit chips 370, 372, 374 and that extend from the integrated circuit chips 370, 372, 374 to other regions of the printed circuit board structure 320 may be implemented using a combination of microstrip transmission line segments 420 and co-planar waveguide transmission line segments 430. The microstrip transmission line segments 420 may be relatively low loss. However, as can be seen in FIG. 7A, the microstrip transmission line segments 420 are also wider than the co-planar waveguide transmission line segments 430 and hence it may be difficult to directly connect a microstrip transmission line segment 420 directly to some of the RF input/output pads 400 on the integrated circuit chips 370, 372, 374.

As known in the art, a coplanar waveguide transmission line refers to a printed circuit board based transmission line structure that includes a conductive track that is formed on a first side of a dielectric substrate and a ground plane that is formed on a second opposed side of the dielectric substrate. A pair of ground (return) conductors are formed on either side of the conductive track on the first side of the dielectric substrate, and hence are co-planar with the conductive track. The return conductors are separated from the conductive track by respective small gaps that typically have unvarying widths along the length of the co-planar waveguide transmission line. Metal-filled ground vias 432 are provided that connect the return conductors to the ground plane on the second side of the dielectric substrate.

As shown in FIG. 7A, pursuant to embodiments of the present invention, various of the RF transmission lines 410 may be implemented using both microstrip and co-planar waveguide transmission line segments 420, 430. The co-planar waveguide transmission line segments 430 may connect to the RF input/output pads 400, while the microstrip transmission line segments 420 may be used in regions remote from the integrated circuit chips where there is additional room for wider transmission line segments. The transitions between the co-planar waveguide transmission line segments 430 and the microstrip transmission line segments 420 may be designed to have a substantially constant impedance to reduce or minimize transmission loss, and the co-planar waveguide transmission line segments 430 may have an improved impedance match with the integrated circuit chips to provide improved return loss performance.

FIG. 7B illustrates the use of RF transmission lines having mixed co-planar waveguide transmission line segments 430 and microstrip transmission line segments 420 in the “rear end” portions of the active antenna channels 362 that include the variable attenuators 366, 378, variable phase shifters 368, 376 and second transmit/receive switch 364. In the depicted embodiments, a single beamforming RF integrated circuit chip (“RFIC”) 365 is used to implement the transmit and receive path variable attenuators 366, 378, the transmit and receive path variable phase shifters 368, 376 and the second transmit/receive switch 364. Two of the three RF transmission lines 410 that connect to the beamforming RFIC 365 are implemented as microstrip transmission lines 420 that have a co-planar waveguide transmission line segment 430 connected thereto that connect to the RF input/output pads 400 to provide a good impedance match thereto. The third transmission line 410 that connects to the beamforming RFIC 365 is implemented as a co-planar transmission line 430 that directly connects the beamforming RFIC 365 to one of two additional attenuators 378 that are provided along the receive path.

FIGS. 8A-8C are three plan views of portions of the first and fourth layers of an example implementation of the printed circuit board structure 320 of FIGS. 5A-5B that illustrate portions of a local oscillator distribution network that are used to distribute a 13 GHz local oscillator signal from the local oscillator synthesizer 336 to each of the four mixers 334.

FIG. 8A is a view of a portion of the top metallization layer 324-1 of the example implementation of the printed circuit board 320. As shown in FIG. 8A, a Wilkinson power divider 450 is implemented on patterned metal layer 324-1. As discussed above, a 13 GHz local oscillator synthesizer integrated circuit chip 392 (see FIG. 5A) is mounted on the top metallization layer 324-1 of printed circuit board structure 320. The 13 GHz local oscillator signal that is generated by the local oscillator synthesizer integrated circuit chip 392 is amplified by an amplifier. Wilkinson power divider 450 is used to split the amplified local oscillator signal into two equal parts. FIG. 8B is a plan view of stripline transmission lines patterned metallization layer 324-3 of the example implementation of the printed circuit board 320, with the metal traces on patterned metal layer 324-1 that form the Wilkinson power divider 450 superimposed thereon to provide perspective. As shown in FIG. 8B, the inputs and outputs of the Wilkinson power divider 450 connect to patterned metallization layer 324-3 through vertical transitions. Stripline transmission line segments 470-1, 470-2, 470-3 are formed in the interior of the printed circuit board structure 320. In particular, conductive tracks 472 are formed on metallization layer 324-4. Conductive vias 474 are formed through the printed circuit board structure 320 along either side of the conductive tracks 472. Ground planes (not visible in the figures) are provided on metallization layers 324-2 and 324-4, so that the conductive tracks 472 are each enclosed by the ground planes and the conductive vias 474 to complete the stripline transmission line segments 472. The stripline transmission line segments 472 are used because they have low radiated loss and because they prevent multiple transmission line crossovers that would otherwise be needed if routed on the top metalization layer.

Each stripline transmission line segments 470 is connected to an input of a respective Wilkinson power divider 480-1, 480-2 on metallization layer 324-3. FIG. 8C is a plan view of a small portion of patterned metallization layer 324-4 of the example implementation of the printed circuit board 320. The four (total) outputs of the Wilkinson power divider 480-1, 480-2 provide the 13 GHz local oscillator signal to the four upconverter/downconverters 334 that are discussed above with reference to FIG. 6.

As noted above, vertical transitions are included in the printed circuit board structure 320 that transition the input and outputs of the Wilkinson power divider 450 between the first patterned metallization layer 324-1 and the fourth patterned metallization layer 324-4. These vertical transitions may be implemented, for example, using any of the vertical transition structures disclosed in U.S. Provisional Patent Application Ser. No. 62/573,244, titled Vertical Transitions for Microwave and Millimeter Wave Communications Systems Having Multi-Layer Substrates, Attorney Docket No. 9833-1421-PR, filed Oct. 17, 2017, the entire content of which is incorporated herein by reference.

FIG. 9A is an enlarged view of a portion an example implementation of the printed circuit board structure 320 of FIGS. 5A-5B illustrating one possible implementation of the bidirectional mixer/filter blocks 330.

As shown in FIG. 9A, the bidirectional mixer/filter block 330 includes an up/down converter 334 that multiplies the 2 GHz data signal by a local oscillator signal to up-convert the 2 GHz data signal to 28 GHz. The up/down converter 334 receives a 13 GHz local oscillator signal from one of the Wilkinson power dividers 480 discussed above. The up/down converter 334 generates a 26 GHz signal from the 13 GHz local oscillator signal and multiplies the 2 GHz signal by the 26 GHz signal to up-convert the 2 GHz signal to 28 GHz signal for transmission.

The 28 GHz signal output from the up/down converter 334 is passed to a first circulator 338. The first circulator 338 routes the 28 GHz signal to an amplifier 340 that increases the signal level to maintain an acceptable signal-to-noise ratio. The output of the amplifier 340 is fed to a second circulator 342 which feeds the signal to a filter 346. Signals received by the phased array antenna 380 are passed in the reverse direction from the second circulator 342 to the up/down converter 334, except that the second circulator 342 routes the received signals through amplifier 348, which increases the level of the received signal to maintain an acceptable signal-to-noise ratio.

As is further shown in FIG. 9A, the second circulator 342 connects to the filter 346 through a microstrip transmission line 600. The end of the microstrip transmission line 600 that terminates into the filter 346 transitions first into a co-planar waveguide segment 610 and then to a co-planar waveguide to substrate integrated waveguide transition 620. The co-planar waveguide to substrate integrated waveguide transition 620 performs impedance matching to provide a low loss transition between the two different types of transmission line structures. The filter 346 is implemented as a four cavity substrate integrated waveguide filter. As known to those of skill in the art, a substrate integrated waveguide transmission line is a waveguide structure that is formed in a multi-layer substrate (e.g., a printed circuit board) that includes a dielectric substrate with upper and lower metal layers formed thereon and two rows of conductive posts (e.g., metal-plated or metal-filled posts) that connect the upper metal layer to the lower metal layer. The combination of the two metal layers and the two rows of metal posts may define a rectangular waveguide structure in the dielectric substrate that RF signals may be transmitted through.

The filter 346 may filter out intermodulation products generated at the up/down converter 334 and any other unwanted signals or noise. For example, the filter 346 may comprise a bandpass filter. The filter 346 may be tuned to pass the desired (28 GHz) signals while filtering out signals and noise in other frequency bands by varying the width and/or length of each cavity 630 thereof. As described above, the mixer 334 multiplies a 2 GHz intermediate frequency signal with a 26 GHz local oscillator signal that is generated by doubling a 13 GHz local oscillator signal in the mixer 334. As a result, intermodulation products may be created at 11 GHz, 15 GHz and 24 GHz along with the desired 28 GHz signal, and 13 GHz and 26 GHz signals may also couple onto the transmission path. The substrate integrated waveguide filter 346 may filter out these intermodulation products along with other out-of-band noise.

In some embodiments, holes may be drilled through the printed circuit board structure 320 that extend through the filter 346. These holes may be filled with air. If properly designed in terms of size and spacing, the holes will not result in material leakage of RF energy flowing through the filter 346. The holes, however, may reduce the overall dielectric constant within the interior of the substrate integrated waveguide filter 346, which may advantageously reduce transmission losses. FIG. 9B is a schematic diagram illustrating an example implementation of a substrate integrated waveguide filter 800 that includes such air-filled holes that reduce the dielectric loss of the filter.

As shown in FIG. 9B, the substrate integrated waveguide filter 800 is formed in a printed circuit board 802 that has a dielectric substrate 810, a first metal layer 820 that is formed on a top surface of the dielectric substrate 810 and a second metal layer 830 that is formed on a bottom surface of the dielectric substrate 810. The first metal layer 820 may define a top surface of the substrate integrated waveguide filter 800 and the second metal layer 830 may define a bottom surface of the substrate integrated waveguide filter 800.

The substrate integrated waveguide filter 800 further includes a set of first conductive vias 840, each of which extends through the printed circuit board 802. The first conductive vias 840 may extend in a row to define a first sidewall 860 of the substrate integrated waveguide filter 800. The substrate integrated waveguide filter 800 also includes a set of second conductive vias 842, each of which extends through the printed circuit board 802. The second conductive vias 842 may extend in a row to define a second sidewall 870 of the substrate integrated waveguide filter 800. A set of third conductive vias 844 are provided that are between the first conductive vias 840 and the second conductive vias 842. The third conductive vias 844 may divide an interior of the substrate integrated waveguide filter 800 into at least two cavities 880, 882. Additionally, a plurality of air-filled openings 850 extend through the first metal layer 820, the dielectric substrate 810 and the second metal layer 830, the air-filled openings 850 extending through an interior of the substrate integrated waveguide filter 800. While not shown in FIG. 9B, the substrate integrated waveguide filter 800 may further include a co-planar waveguide to substrate integrated waveguide transition 620.

Pursuant to additional embodiments of the present invention, techniques are provided for reducing the overall surface area on the printed circuit board structure required to implement the active antenna channels 362. In particular, FIG. 10 is a schematic block diagram of the printed circuit board structure 320 of FIGS. 5A-5B that illustrates how the front-end sections 363 of the active antenna channels 362 may be staggered with respect to each other and how some of the active antenna channels 362 may wrap around the sides of the phased array antennas 380 to further reduce the width of the printed circuit board structure 320.

As shown in FIG. 10, the placement of the front end sections 363 of the active antenna channels 362 are staggered, with some of the front end sections 363 being placed in close proximity to the phased array antennas 380, while others are located at significantly larger distances from the phased array antennas 380. This arrangement allows the active antenna channels 362 to be placed closer together, reducing the width of the printed circuit board structure 320 and distributing the power amplifier heat load over a larger surface area. As can also be seen in FIG. 10, the front end sections 363 of the two active antenna channels 362 at the end of each channel group 360 wrap around the sides of the phase array antennas 380. This allows for further reduction in the width of the printed circuit board structure 320.

As is further shown in FIG. 10, walls 650 of conductive vias 652 are formed through the printed circuit board structure 320. The walls 650 of conductive vias 652 may be formed in the locations where the EMI shield cover 316 contacts the printed circuit structure 320 so that the walls 650 of conductive vias 652 extend underneath the downwardly-extending walls 317 of the EMI shield cover 316. The walls 650 of conductive vias 652 provide additional isolation between adjacent active antenna channels 362.

Thus, pursuant to some embodiments of the present invention, millimeter wave communications systems are provided that include an RF printed circuit board structure. The RF printed circuit board structure may include a phased array antenna that has a plurality of radiating elements and a channel block that includes a plurality of active antenna channels that each feed a respective one of a plurality of sub-groups of the radiating elements. A first sub-set of the active antenna channels may be completely positioned on a first side of the phased array antenna and a second sub-set of the active antenna channels may each include a first portion that is on a second side of the phased array antenna, the second side being adjacent the first side.

The second sub-set of the active antenna channels may include, for example, a total of one or two active antenna channels in some embodiments. Second portions of all of the active antenna channels may extend generally in the same direction. The radiating elements may be arranged in a plurality of rows and a plurality of columns, and each active antenna channel may be connected to a respective one of the columns of radiating elements. In some embodiments, each active antenna channel may include a high power amplifier and a low noise amplifier, where the high power amplifier and the low noise amplifier of a first of the active antenna channels is positioned closer to the phased array antenna than are the high power amplifier and the low noise amplifier of the second of the active antenna channels.

FIG. 11 is a plan view of an example implementation of one of the power couplers 350. As shown in FIG. 11, the power coupler 350 may be implemented using seven Wilkinson power couplers 354-1 through 354-7 that are arranged in a root/branch structure so that, for signals travelling in the “transmit” direction, the power coupler 350 has a single input 351 and eight outputs 352 (for signals travelling in the “receive” direction the power coupler 350 has eight inputs 352 and a single output 351). Transmission line segments 356 extend between the inputs and outputs of the Wilkinson power dividers 354 and form the outputs 352 of the power coupler 350.

As is further shown in FIG. 11, a plurality of meandered delay lines 358 are incorporated into various of the transmission line segments 356. The meandered delay lines 358 are used to compensate for differences in the path lengths from the input 351 of power coupler 350 to the eight columns 386 of the phased array antenna 380. If there are delay differences along these eight paths, then the amplitude and/or phase weights that are applied by the variable attenuators 366, 378 and variable phase shifters 368, 376 in the active antenna channels 362 may only produce a desired beam pattern over a narrower range of frequencies. The meandered delay lines 358 increase the path length on certain of the paths to provide substantially equal path lengths.

Each meandered delay line 358 may comprise a transmission line segment that has a series of opposed bends that form a serpentine pattern. In some embodiments, the meandered delay lines 358 may extend along a longitudinal axis and the serpentine pattern may be used to increase the physical length of the transmission path by, for example, a factor of two or three or more. Each meandered delay line 358 may be implemented using a co-planar waveguide transmission line segment, while most or all of the remainder of the transmission lines in power coupler 350 may be implemented as microstrip transmission line segments. Implementing each meandered delay line 358 using a co-planar waveguide transmission line segment may allow for greater transmission line length in a given area, since the co-planar waveguide transmission line segment has a smaller width. Additionally, since the co-planar waveguide transmission line segments have ground conductors on either side of the conductive track, it may do a better job than a microstrip transmission line segment at reducing coupling between adjacent bends of the meandered delay lines 358.

As is also shown in FIG. 11, the outputs of Wilkinson power couplers 354-1, 354-2 and 354-3 connect to the inputs of Wilkinson power couplers 354-4 through 354-7. For example, the first output of Wilkinson power coupler 354-1 connects to the input of Wilkinson power coupler 354-2 via a first transmission line segment 356-1 while the second output of Wilkinson power coupler 354-1 connects to the input of Wilkinson power coupler 354-3 via a second transmission line segment 356-2. The lengths of transmission line segments 356-1 and 356-2 are different. The use of transmission line segments having asymmetric lengths in the power coupler 350 allows for equalizing the total path length from the input 351 of power coupler to each of the columns 386 of the phased array antenna 380. In other words, the asymmetric lengths of the transmission line segments 356 and the meandered delay lines 358 compensate for the differences in path lengths in the active antenna channels 362 that are caused, for example, by having some of the active antenna channels 362 wrap around the phased array antennas 380. This technique may be used to ensure that all of the sub-components of an RF signal to be transmitted arrive at the first radiating element 382 in each column 386 of the phased array antenna 380 at the same time.

Thus, pursuant to some embodiments of the present invention, power couplers for a millimeter wave communications system are provided that include a first 1×2 power coupler having a first input, first output and a second output; a second 1×2 power coupler having a second input that is coupled to the first output by a first transmission line segment; and a third 1×2 power coupler having a third input that is coupled to the second output by a second transmission line segment. The first transmission line segment includes a meandered delay line. The meandered delay line may comprise, for example, a co-planar waveguide meandered delay line and at least another portion of the first transmission line segment may comprise a microstrip transmission line segment. The 1×2 power couplers may be, for example, Wilkinson power couplers.

In some embodiments, the power couplers may further include a fourth 1×2 power coupler having a fourth input and a fifth 1×2 power coupler having a fifth input. In such embodiments the second 1×2 power coupler may have a third output that is coupled to the fourth input by a third transmission line and a fourth output that is coupled to the fifth input by a fourth transmission line, where the third transmission line is longer than the fourth transmission line.

FIG. 12 is a schematic diagram illustrating heat sink structures 550 that are included in an example implementation of the printed circuit board structure 320 of FIGS. 5A-5B to dissipate heat generated in the integrated circuit chips mounted thereon. As shown in FIG. 12, each heat sink structure 550 may comprise a dense pattern of conductive vias 552 that are formed through the printed circuit board structure 320. The conductive vias 552 may be formed directly underneath various of the integrated circuit chips, including the amplifier integrated circuit chips, to provide a thermal conduction path that may be used to vent heat generated in the integrated circuit chips out of the printed circuit board structure 320. Referring to FIGS. 4B and 13, a top end of each conductive via 552 may contact an integrated circuit chip 315, while a bottom end of each conductive via 552 may contact one of the pedestals 314 of the baseplate 310.

FIG. 13 is a plan view of an example implementation of the printed circuit board structure 320 of FIGS. 5A-5B that illustrates via fence structures 700 and DC bias coupling circuits 720 that are implemented in the printed circuit board structure 320. The via fence structures 700 are provided between the microstrip transmission lines 710 that connect each active antenna channel 362 to a column 386 of one of the phased array antennas 380. As shown in FIG. 13, in regions where two of these microstrip transmission lines 710 extend in parallel in close proximity to each other, a via fence structure 700 may be formed between the adjacent microstrip transmission lines 710. Each via fence structure 700 may comprise a row of conductive vias 702 that extend through the printed circuit board structure 320. A metal trace 704 may be provided on the metallization layer 324-1 that electrically connects the conductive vias 702 of the via fence structure 700. The metal trace 704 may improve the isolation between adjacent microstrip transmission lines 710.

FIG. 13 also illustrates DC bias signal injection circuits 720 that may be used to inject DC control signals onto the microstrip transmission lines 710 that are used to control the PIN diode switches that are included in each column 386 of each phased array antenna that are used to implement elevation beamwidth switching. The PIN diode switches and operation thereof are described in greater detail in the aforementioned U.S. Provisional Patent Application Ser. No. 62/506,100, entitled Phased Array Antennas Having Switched Elevation Beamwidths and Related Methods, Attorney Docket No. 9833-1221-PR, filed May 15, 2017. The DC bias signal injection circuits 720 may be implemented as a narrow, quarter wavelength long conductive trace 722 that connects a DC bias voltage source (here a conductive via 724 that carries a DC voltage) to one of the microstrip transmission lines 710. Each third transmit/receive switch 372 includes a capacitor that also acts as part of the respective DC bias signal injection circuits 720. DC bias signals are passed from the conductive via 724 to the microstrip transmission line 710 through the quarter wavelength long conductive trace 722. The quarter wavelength long conductive trace 722 blocks RF signals carried on microstrip transmission line 710 from flowing to the conductive via 724. The capacitor in each third transmit/receive switch 372 prevents the DC bias signal from flowing into the active antenna channels 362.

FIG. 14 is a plan view of an example implementation of the four phased array antennas 380 included in the printed circuit board structure 320. As can be seen in FIG. 14, each patch radiating element 382 in a column 386 connects to a feeder transmission line segment 388 via a feed 389. In the phased array antennas 380-1, 380-2 that are located at the top of the figure, each feed 389 defines a line that bisects the patch radiating element 382 at an angle of −45 degrees with respect to an axis V while in the phased array antennas 380-3, 380-4 that are located at the bottom of the figure, each feed 389 defines a line that bisects the radiating element at an angle of +45 degrees with respect to the axis V. Thus, the patch radiating elements 382 in phased array antennas 380-1, 380-2 will transmit and receive signals at a −45 degree polarization, while the patch radiating elements 382 in phased array antennas 380-3, 380-4 will transmit and receive signals at a +45 degree polarization.

By implementing the phased array antennas 380 to have two different polarizations, increased isolation may be provided between the phased array antennas 380 when the millimeter wave communications system 60 operates using MIMO transmission techniques. In other words, in addition to spatial diversity, the radio unit 100 will have polarization diversity between some of the phased array antennas 380. Additionally, since the two phased array antennas 380 in the “top row” have the same polarization, the radio unit 100 may alternatively be operated with the phased array antennas 380-1, 380-2 operating as a first, 16 column antenna and the phased array antennas 380-3, 380-4 operated as a second, 16 column antenna. When operated in this fashion, the radio unit 100 may transmit in a 2×MIMO mode using the two 16-column antennas. By combining two of the phased array antennas 380 into a “larger” antenna the azimuth beamwidth may be further narrowed and the antenna gain increased. In rural areas where subscribers are spaced farther apart operation in 2×MIMO mode may be preferred, while 4×MIMO operation may provide better performance in urban areas.

The millimeter wave communications systems according to embodiments of the present invention may support high performance levels. As discussed above, each millimeter wave communications system includes four phased array antennas and hence may support 4×MIMO transmissions to provided increased throughput. Additionally, each antenna may be actively scanned in the azimuth plane and beamwidth switching may be provided in the elevation plane to provide relatively high gain antenna beams while still ensuring that the radio unit may provide coverage to all of the users within its coverage area. The millimeter wave communications systems may support very high effective isotropic radiated power (“EIRP”) levels due to the above-discussed high antenna gains and because the millimeter wave communications systems have multi-stage amplification on the RF board.

The millimeter wave communications systems according to embodiments of the present invention may also be very compact and relatively inexpensive. The use of elevation beamwidth switching allows the phased array antennas included in the millimeter wave communications systems according to embodiments of the present invention to have most of the capabilities of a full two dimensional active antenna array while only requiring 12.5% of the active transceivers that are necessary for a fully active 8×8 phased array antenna. This reduction in electronic components provides a highly cost-effective implementation and also reduces the size of the millimeter wave communications system.

The present invention has been described above with reference to the accompanying drawings. The invention is not limited to the illustrated embodiments; rather, these embodiments are intended to fully and completely disclose the invention to those skilled in this art. In the drawings, like numbers refer to like elements throughout. Thicknesses and dimensions of some elements may not be to scale.

Spatially relative terms, such as “under”, “below”, “lower”, “over”, “upper”, “top”, “bottom” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity. As used herein the expression “and/or” includes any and all combinations of one or more of the associated listed items.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention.

It will be understood that the above embodiments may be combined in any way to provide a plurality of additional embodiments.

1. A millimeter wave communications system, comprising:
a radio frequency (“RF”) printed circuit board structure that includes:
a phased array antenna that includes a plurality of radiating elements;
a channel block that includes a plurality of active antenna channels that each feed a respective one of a plurality of sub-groups of the radiating elements,
wherein a first sub-set of the active antenna channels are completely positioned on a first side of the phased array antenna and a second sub-set of the active antenna channels each include a first portion that is on a second side of the phased array antenna, the second side being adjacent the first side.

2. The millimeter wave communications system of claim 1, wherein the second sub-set of the active antenna channels includes a total of one active antenna channel.

3. The millimeter wave communications system of claim 1, wherein the second sub-set of the active antenna channels includes no more than two active antenna channels.

4. The millimeter wave communications system of claim 1, wherein second portions of all of the active antenna channels extend generally in the same direction.

5. The millimeter wave communications system of claim 1, wherein the radiating elements are arranged in a plurality of rows and a plurality of columns, and wherein each active antenna channel is connected to a respective one of the columns of radiating elements.

6. The millimeter wave communications system of claim 1, wherein each active antenna channel includes a high power amplifier and a low noise amplifier, wherein the high power amplifier and the low noise amplifier of a first of the active antenna channels are positioned closer to the phased array antenna than are the high power amplifier and the low noise amplifier of the second of the active antenna channels.

7. A power coupler for a millimeter wave communications system, comprising:
a first 1×2 power coupler having a first input, first output and a second output;
a second 1×2 power coupler having a second input that is coupled to the first output by a first transmission line segment;
a third 1×2 power coupler having a third input that is coupled to the second output by a second transmission line segment;
wherein the first transmission line segment includes a meandered delay line.

8. The power coupler of claim 7, further comprising:
a fourth 1×2 power coupler having a fourth input; and
a fifth 1×2 power coupler having a fifth input;
wherein the second 1×2 power coupler has a third output that is coupled to the fourth input by a third transmission line and a fourth output that is coupled to the fifth input by a fourth transmission line, wherein the third transmission line is longer than the fourth transmission line.

9. The power coupler of claim 7, wherein the meandered delay line comprises a co-planar waveguide meandered delay line and at least another portion of the first transmission line segment comprises a microstrip transmission line segment.

10. The power coupler of claim 7, wherein the first second and third 1×2 power couplers each comprise a Wilkinson power coupler.

11. A millimeter wave communications system, comprising:
a baseplate;
a radio frequency (“RF”) printed circuit board structure mounted on the baseplate;
an EMI shield cover mounted on the RF printed circuit board structure opposite the baseplate;
wherein the RF printed circuit board structure includes a phased array antenna and a plurality of active antenna channels formed therein, and
wherein the EMI shield cover includes at least a first cavity that covers a first portion of a first of the active antenna channels and a separate second cavity that covers a second portion of the first of the active antenna channels.

12. The millimeter wave communications system of claim 11, wherein the EMI shield cover includes downwardly extending walls that contact the RF printed circuit board structure, and wherein respective lines of conductive vias are formed in the RF printed circuit board structure underneath at least some of the downwardly extending walls of the EMI shield cover.

13. The millimeter wave communications system of claim 11, wherein a first integrated circuit chip amplifier is mounted on the RF printed circuit board structure within the first cavity and a second integrated circuit chip amplifier is mounted on the RF printed circuit board structure within the second cavity.

14. The millimeter wave communications system of claim 11, wherein a window is provided between the first cavity and the second cavity.

15-18. (canceled)
